(19) United States
(12) Patent Application Publication
(10) Pub. No.: US 2024/0004698 A1
(43) Pub. Date: Jan. 4, 2024

(54) DISTRIBUTED PROCESS ENGINE IN A DISTRIBUTED COMPUTING ENVIRONMENT

(71) Applicant: RED HAT, INC., Raleigh, NC (US)

(72) Inventors: Tiago Dolphine, Sao Paulo (BR); Edoardo Vacchi, Milan (IT)

(21) Appl. No.: 17/856,803

(22) Filed: Jul. 1, 2022

(51) Int. Cl. G06F 15/163

(52) U.S. Cl. CPC G06F 15/163

(57) ABSTRACT

A distributed computing environment can include a distributed process engine. For example, a computing device can receive, by a process engine distributed across a plurality of nodes of a distributed computing environment, a description of a process comprising a plurality of deployment units. The process can be associated with a graph representing a plurality of tasks to be performed to complete the process. The description can define relationships between the plurality of deployment units. The computing device can deploy, by the process engine, the plurality of deployment units in the distributed computing environment. The computing device can cause, by the process engine, an action associated with an execution of one or more deployment units of the plurality of deployment units.

### TECHNICAL FIELD

The present disclosure relates generally to distributed computing systems. More specifically, but not by way of limitation, this disclosure relates to a containerized distributed process engine.

### BACKGROUND

There are various types of distributed computing environments, such as cloud computing systems, computing clusters, and data grids. A distributed computing system can include multiple nodes (e.g., physical machines or virtual machines) in communication with one another over a network, such as a local area network or the Internet. Cloud computing systems have become increasingly popular. Cloud computing environments have a shared pool of computing resources (e.g., servers, storage, and virtual machines) that are used to provide services to users on demand. These services are generally provided according to a variety of service models, such as Infrastructure as a Service, Platform as a Service, or Software as a Service. But regardless of the service model, cloud providers manage the physical infrastructures of the cloud computing environments to relieve this burden from users, so that the users can focus on deploying software applications.

### BRIEF DESCRIPTION OF THE DRAWINGS

FIG. 1 is a block diagram of an example of a system for implementing a distributed process engine in a distributed computing environment according to some aspects of the present disclosure.

FIG. 2 is a block diagram of an example of deployment units for execution by a distributed process engine according to some aspects of the present disclosure.

FIG. 3 is a block diagram of another example of a system for implementing a distributed process engine in a distributed computing environment according to some aspects of the present disclosure.

FIG. 4 is a flow chart of an example of a process for implementing a distributed process engine in a distributed computing environment according to some aspects of the present disclosure.

### DETAILED DESCRIPTION

A business process model and notation (BPMN) model can define a model that can be executed in a distributed computing environment by a process engine that is able to interpret or compile the BPMN model into an executable. A process can be deployed as one or more containerized services, or deployment units. Deploying a process as a single deployment unit may be suboptimal if tasks of the process would benefit from being deployed separately. So, a process can be broken down into a separate deployment units for each task, which may be suboptimal since not all tasks may be worth deploying as a stand-alone service. Accordingly, a process may be broken down into deployment units at arbitrary boundaries that do not necessarily coincide with task boundaries. But, in any case, there is a notable lack of a standard way to coordinate execution across such deployment units and relating the deployment units to their parent process. The lack of coordination, in turn, prevents the process engine from embracing container-based deployment and execution paradigms. In addition, the process engine typically is not aware of relationships between the deployment units, which can result in the process engine suboptimally managing resources of the distributed computing environment.

Some examples of the present disclosure can overcome one or more of the abovementioned problems by providing a distributed process engine that is a centralized, consistent mechanism for management of deployment units that conserves the relation between the deployed units. The distributed process engine can schedule and coordinate execution of each deployment unit, perform administration tasks, such as aborting, restarting, and resuming processes, trace an execution across processes and their related deployment units, and address and route messages between deployment units. Deploying a process as multiple deployment units may be error-prone and expensive. But, the distributed process engine can provide a communication channel between the deployment units so that the deployment units can communicate with each other to accurately execute the process even if deployment units fail or are redeployed. In addition, the distributed process engine can take action to reduce operational and infrastructure-related costs, such as by automatically shutting down deployment units.

As an example, the system can receive, by a process engine distributed across nodes of a distributed computing environment, a description of a process that involves one or more deployment units. The process can be associated with a graph representing a tasks to be performed to complete the process. The description can define relationships between the deployment units, such as a sequence of an execution of the deployment units. The system can deploy, by the process engine, the deployment units in the distributed computing environment. The system can then cause, by the process engine, an action associated with an execution of one or more deployment units of the plurality of deployment units. For instance, the action may be creating a process instance by performing the execution of the deployment units, manipulating a lifecycle of the process instance by starting, stopping, resuming, or restarting the process instance, manipulating a property associated with the process instance by adjusting a runtime state of the process during the execution of the deployment units, or tracing the execution of the deployment units through execution metrics associated with the process.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

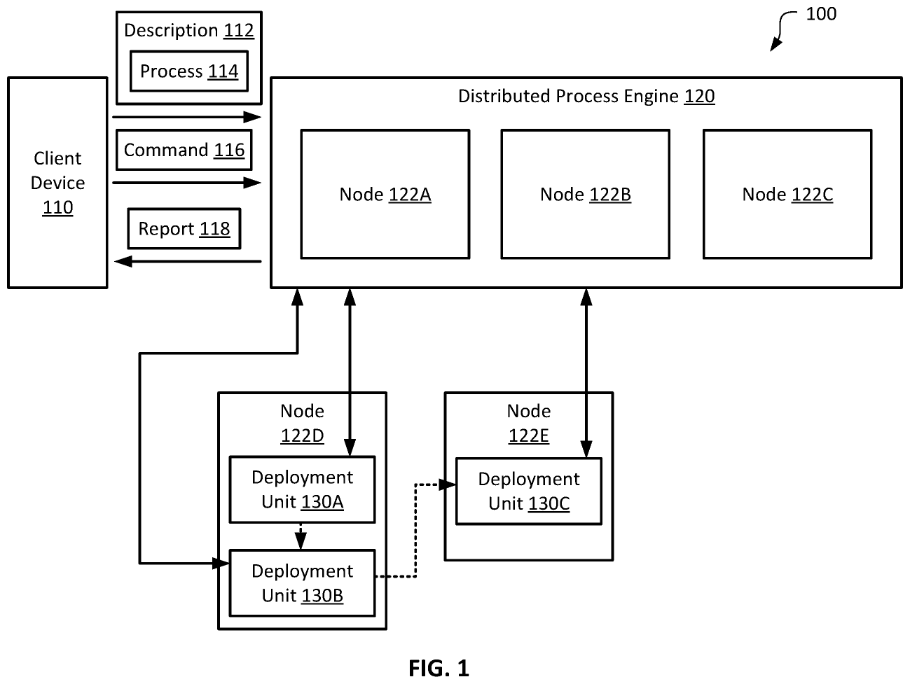

FIG. 1 is a block diagram of an example of a system 100 for implementing a distributed process engine in a distributed computing environment according to some aspects of the present disclosure. The system 100 includes a client device 110 and nodes 122A-E. Examples of the client device 110 include a mobile device, a desktop computer, a laptop computer, etc. The nodes 122A-E may be part of a distributed computing environment, such as distributed storage system, a cloud computing system, or a cluster computing system. The nodes 122A-E may be physical servers for executing containers. Some of the nodes 122A-E can be part of a distributed process engine 120, which manages the execution of containerized deployment units. For instance, nodes 122A-C are illustrated as being part of the distributed process engine 120, where each of the nodes 122A-C can include software associated with the distributed process engine 120. The nodes 122A-E can communicate with each other and the client device 110 via one or more networks, such as a local area network or the Internet.

In some examples, the distributed process engine 120 is a dedicated service or a collection of services, such as a Kubernetes operator, that can interpret and compile logic described in a model into an executable. For instance, the model may be a business process model and notation (BPMN) model, which is a description of a process 114 in the form of the model. The BPMN model may be a graph with nodes representing one or more tasks to be performed to complete the process 114. The distributed process engine 120 can deploy the process 114 as containerized services by determining deployment units 130A-C for the process 114, where each deployment unit 130 includes at least one of the tasks of the process 114, and then deploying the deployment units 130A-C. Thus, each of the deployment units 130A-C is a containerized service that includes one or more executable tasks of the process 114. To determine the deployment units 130A-C, the distributed process engine 120 can receive a description 112 of the process 114. The description 112 may be a BPMN file that defines the process model associated with the process 114. The description 112 can include a manifest for each deployment unit 130 of the process 114. For instance, a manifest can describe the task(s) of the process 114 that it maps by annotating the BPMN file with metadata that relates the deployment units 130A-C of the process 114 to each other. The distributed process engine 120 may include an operator for inspecting the description 112 for the manifests, which may be exposed through a custom resource description. Or, the manifests may announce themselves to the distributed process engine 120.

The manifests may additionally include an identifier of a communication channel associated with the deployment units 130A-C. The identifier of the communication channel can indicate resources or message channels to which the deployment units 130A-C are to publish or subscribe. The distributed process engine 120 can provide the communication channel between each of the deployment units 130A-C based on the manifests. For instance, the distributed process engine 120 may wire Knative channels so that messages are exchanged between Knative-based services or the distributed process engine 120 may setup routes using symbolic identifiers, in which case another service may provide lookup and setup capabilities for such channels or routes.

In some examples, the distributed process engine 120 can deploy the deployment units 130A-C to nodes 122D-E so that the nodes 122D-E can execute the deployment units 130A-C. An executing process may be referred to as a process instance. FIG. 1 illustrates deployment units 130A-B being deployed to node 122D and deployment unit 130B being deployed to node 122E. Upon deploying the deployment units 130A-C, the distributed process engine 120 can cause an action associated with an execution of one or more of the deployment units 130A-C. For example, subsequent to deploying the deployment units 130A-C, the distributed process engine 120 may receive a command 116 from the client device 110 to execute the process 114. Based on the description 112, the distributed process engine 120 can determine that deployment unit 130B is to be executed subsequent to deployment unit 130A and prior to deployment unit 130C. For instance, the execution of the deployment unit 130B may depend on a result of executing deployment unit 130A and the execution of the deployment unit 130C may depend on a result of executing deployment unit 130B. The distributed process engine 120 can coordinate the execution of the deployment units 130A-C in accordance with the description 112. So, the distributed process engine 120 can initially trigger the execution of the deployment unit 130A. Then, when the execution of the deployment unit 130A is finished, the deployment unit 130A can send an indication of the end of an execution phase of the deployment unit 130A to the distributed process engine 120. Upon receiving the indication, the distributed process engine 120 can cause the execution of the deployment unit 130B.

Prior to executing the process 114, the distributed process engine 120 may determine that a deployment of the process 114 is incomplete. For example, subsequent to deploying the deployment units 130A-C, the distributed process engine 120 can receive the command 116 from the client device 110 to execute the process 114. The distributed process engine 120 can then validate the correctness and completeness of the deployment units 130A-C according to the description 112. Upon determining that a deployment unit of the deployment units 130A-C is incomplete, the distributed process engine 120 can generate a report 118 indicating that the process 114 is incomplete. The process 114 may be incomplete if the process 114 should include an additional deployment unit other than the deployment units 130A-C, if not all the constituent deployment units 130A-C are deployed, or if some of the deployment units 130A-C are faulty, unreliable, or unhealthy. The action associated with the execution of one or more of the deployment units 130A-C can involve the distributed process engine 120 outputting the report 118 to the client device 110 so that a user associated with the client device 110 can perform actions to complete the process 114.

Since the distributed process engine 120 provides the communication channel between the deployment units 130A-C, the deployment units 130A-C can propagate messages between themselves. The distributed process engine 120 can make the deployment units 130A-C aware of each other so that the deployment units 130A-C can exchange process management commands directly. Upon receiving the command 116 from the client device 110 to execute the process 114, the distributed process engine 120 may send a message associated with the command 116 to the deployment unit 130A. The message may be a start message indicating that the deployment unit 130A is to start execution. Other examples of the message include a stop message, a resume message, or a restart message. Once the execution of the deployment unit 130A ends, the deployment unit 130A can propagate the message to the deployment unit 130B indicating that the deployment unit 130B is to begin execution. So, rather than the deployment unit 130A sending a message back to the distributed process engine 120 after the execution of the deployment unit 130A and the distributed process engine 120 sending another message to the deployment unit 130B, the deployment unit 130A can communicate directly with the deployment unit 130B via the communication channel. The communication channel also allows the deployment units 130A-C to receive command messages directly from the client device 110.

The distributed process engine 120 may be able to collect state information associated with the deployment units 130A-C and present the state information graphically at the client device 110. The distributed process engine 120 may send a request to the deployment units 130A-C requesting the state information for each of the deployment units 130A-C and the deployment units 130A-C can respond to the request with the state information. The distributed process engine 120 can present the state information according to logical, domain-specific relations. For example, the distributed process engine 120 may show a status of the process 114 as a whole by showing the deployment units 130A-C that are currently being executed and the task(s) associated with the deployment units 130A-C. As a particular example, distributed process engine 120 may expose a representational state transfer (REST) interface in which the state information can be displayed graphically. A user may interact with the interface to communicate with the distributed process engine 120 or with the deployment units 130A-C directly.

The distributed process engine 120 may additionally make and execute automated decisions related to the deployment units 130A-C. For instance, the distributed process engine 120 may determine whether a deployment unit is to be put into execution, scaled up, scaled down, etc. As a particular example, the distributed process engine 120 may determine that deployment unit 130A receives a number of requests above a threshold and scale up the node 122D or a container associated with the deployment unit 130A to accommodate the number of requests. The distributed process engine 120 may delegate the decisions to an underlying container orchestrator or take the actions directly when the actions involve domain-knowledge. The container orchestrator can allow containers and message brokers to span boundaries of a single cloud provider associated with the distributed computing environment.

In some examples, the distributed process engine 120 may take an action upon determining that a deployment unit is faulty. For instance, the distributed process engine 120 may determine that the deployment unit 130C is faulty and cause the deployment unit 130C to be redeployed or terminated. In addition, the distributed process engine 120 can ensure that the communication channel across the deployment units 130A-C is kept alive by rerouting messages and requests accordingly.

In summary, by providing the communication channel between the deployment units 130A-C and by coordinating the execution of the deployment units 130A-C, the distributed process engine 120 can perform actions associated with the deployment units 130A-C. For example, the actions can include creating a process instance of the process 114 by performing the execution of the deployment units 130A-C, manipulating a lifecycle of the process instance by starting, stopping, resuming, or restarting the process instance, manipulating a property associated with the process instance by adjusting a runtime state of the process during the execution of the deployment units 130A-C, or tracing the execution of the deployment units 130A-C through execution metrics (e.g., indications of which tasks are executing received from the deployment units 130A-C) associated with the process 114.

It will be appreciated that FIG. 1 is intended to be illustrative and non-limiting. Other examples may include more components, fewer components, different components, or a different arrangement of the components shown in FIG. 1. For instance, although the system 100 includes five nodes in the example of FIG. 1, the system 100 may have hundreds or thousands of storage nodes in other examples. Additionally, the distributed process engine 120 may be deploying and coordinating multiple processes, each with multiple deployment units.

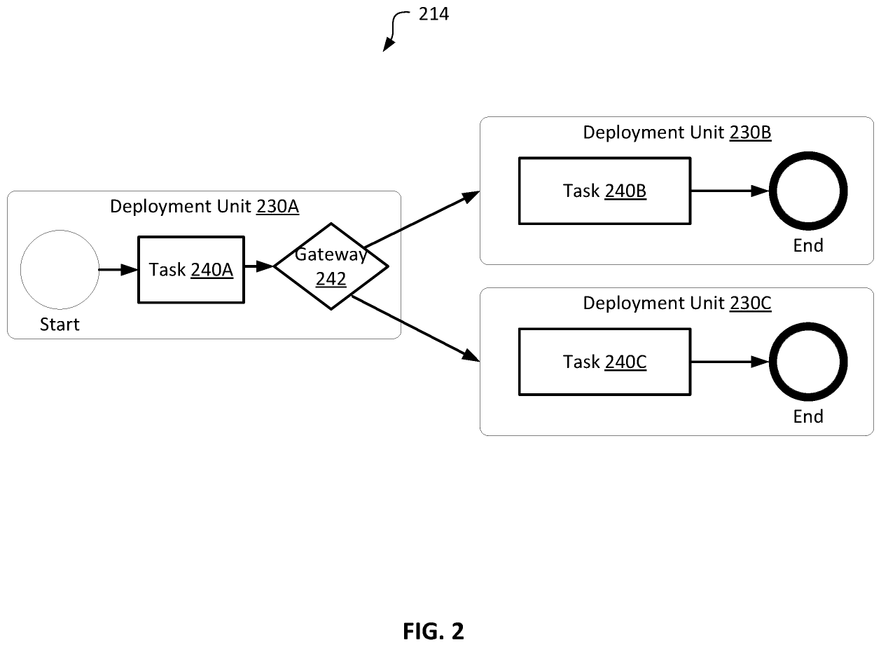

FIG. 2 is a block diagram of an example of deployment units 230 for execution by a distributed process engine (e.g., distributed process engine 120 in FIG. 1) according to some aspects of the present disclosure. The deployment units 230A-C are part of process 214 and each include one or more tasks 240. As illustrated, deployment unit 230A includes a start node, a task 240A, and a gateway 242. The gateway 242 may be an exclusive gateway or a parallel gateway. For an exclusive gateway, more than one edge leaves the gateway 242, but execution continues on only one edge depending on a condition associated with the gateway 242. For a parallel gateway, more than one edge leaves the gateway 242 and execution continues on all the edges. So, if the gateway 242 is an exclusive gateway, execution proceeds to either deployment unit 230B or deployment unit 230C, whereas if the gateway 242 is a parallel gateway, execution proceeds to both deployment unit 230B and deployment unit 230C. Deployment unit 230B includes task 240B and an end node, and deployment unit 230C includes task 240C and an end node. So, based on a description of the process 214 and how the deployment units 230A-C relate to each other, a distributed process engine can configure a communication channel for the deployment units 230A-C and execute the deployment units 230A-C.

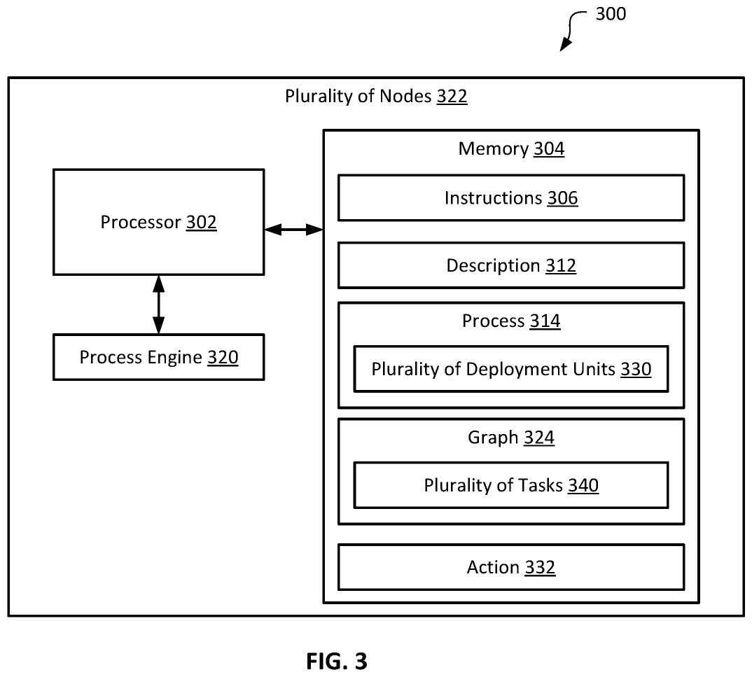

FIG. 3 is a block diagram of another example of a system 300 for implementing a distributed process engine in a distributed computing environment according to some aspects of the present disclosure. The system 300 can be a distributed computing environment that includes a plurality of nodes 322, which includes a process engine 320. The process engine 320 can be distributed across the plurality of nodes 322.

In this example, the plurality of nodes 322 include a processor 302 communicatively coupled with a memory 304. The processor 302 can include one processor or multiple processors. For instance, each node of the plurality of nodes 322 can include a processor and the processor 302 can be the processors of each of the nodes. Non-limiting examples of the processor 302 include a Field-Programmable Gate Array (FPGA), an application-specific integrated circuit (ASIC), a microprocessor, etc. The processor 302 can execute instructions 306 stored in the memory 304 to perform operations. The instructions 306 can include processor-specific instructions generated by a compiler or an interpreter from code written in any suitable computer-programming language, such as C, C++, C#, etc.

The memory 304 can include one memory or multiple memories. Non-limiting examples of the memory 304 can include electrically erasable and programmable read-only memory (EEPROM), flash memory, or any other type of non-volatile memory. At least some of the memory 304 includes a non-transitory computer-readable medium from which the processor 202 can read the instructions 306. The non-transitory computer-readable medium can include electronic, optical, magnetic, or other storage devices capable of providing the processor 302 with computer-readable instructions or other program code. Examples of the non-transitory computer-readable medium can include magnetic disks, memory chips, ROM, random-access memory (RAM), an ASIC, optical storage, or any other medium from which a computer processor can read the instructions 306.

In some examples, the processor 302 can execute the instructions 306 to perform operations. For example, the processor 302 can receive, by the process engine 320 distributed across the plurality of nodes 322 of a distributed computing environment, a description 312 of a process 314. The process 314 can include a plurality of deployment units 330. The process 314 can be associated with a graph 324 representing a plurality of tasks 340 to be performed to complete the process 314. The description 312 can define relationships between the plurality of deployment units 330. The processor 302 can deploy, by the process engine 320, the plurality of deployment units 330 in the distributed computing environment. The processor 302 can cause, by the process engine 320, an action 332 associated with an execution of one or more deployment units of the plurality of deployment units 330. The process engine 320 can provide coordinated execution across the plurality of deployment units 330 relate the plurality of deployment units 330 to the process 314. This, in turn, allows the system 300 to embrace container-based deployment and execution paradigms, such as a serverless distributed computing environment. Making the system 300 aware of the relationship between the plurality of deployment units 330 provides the possibility to dynamically allocate resources to accommodate the load of requests.

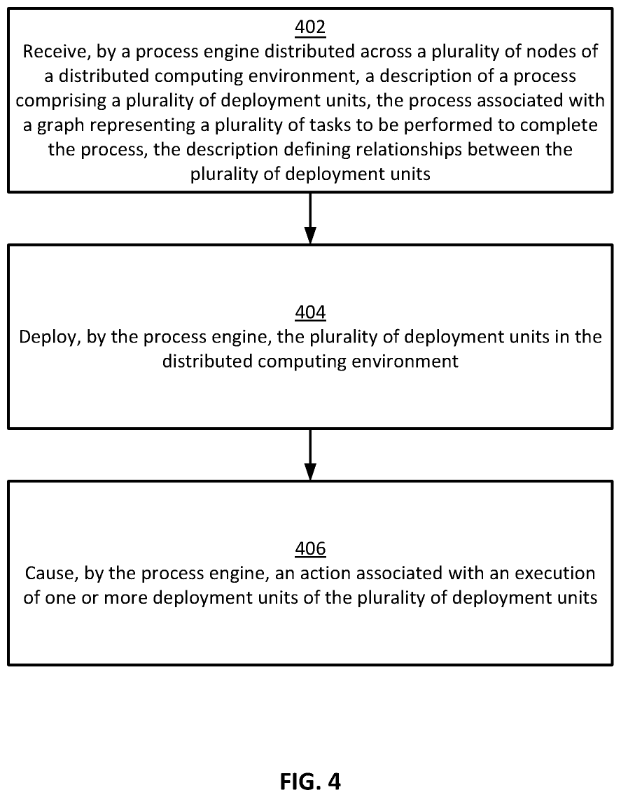

FIG. 4 is a flow chart of an example of a process for implementing a distributed process engine in a distributed computing environment according to some aspects of the present disclosure. In some examples, the processor 302 can implement some or all of the steps shown in FIG. 4. Other examples can include more steps, fewer steps, different steps, or a different order of the steps than is shown in FIG. 4. The steps of FIG. 4 are discussed below with reference to the components discussed above in relation to FIG. 3.

In block 402, the processor 302 can receive, by a process engine 320 distributed across a plurality of nodes 322 of a distributed computing environment, a description of a process 314 comprising a plurality of deployment units 330. The process 314 is associated with a graph 324 representing a plurality of tasks 340 to be performed to complete the process 314. The description 312 can define relationships between the plurality of deployment units 330. For example, the description 312 can be a BPMN file that defines the graph 324. Each deployment unit of the plurality of deployment units 330 can be a containerized service including one or more tasks of the plurality of tasks 340 of the process 314. The processor 302 can receive a plurality of manifests describing the plurality of deployment units 330, where each manifest of the plurality of manifests corresponds to a deployment unit of the plurality of deployment units 330. In addition, each manifest can include an identifier of a communication channel associated with the deployment unit. The processor 302 can provide, by the process engine 320, the communication channel between each deployment unit of the plurality of deployment units 330.

In block 404, the processor 302 can deploy, by the process engine 320, the plurality of deployment units 330 in the distributed computing environment. The process engine 320 can deploy the plurality of deployment units 330 to one or more nodes of the plurality of nodes 322 so that the nodes can execute the deployment units 330.

In block 406, the processor 302 can cause, by the process engine 320, an action 332 associated with an execution of one or more deployment units of the plurality of deployment units 330. For example, the action 332 may involve triggering the execution of the one or more deployment units. Additionally or alternatively, the action 332 may involve outputting a report to a client device upon determining the process 314 is incomplete. Other examples of the action 332 include creating a process instance of the process 314 by performing the execution of the plurality of deployment units 330, manipulating a lifecycle of the process instance by starting, stopping, resuming, or restarting the process instance, manipulating a property associated with the process instance by adjusting a runtime state of the process 314 during the execution of the plurality of deployment units 330, or tracing the execution of the plurality of deployment units 330 through execution metrics associated with the process 314.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A system comprising:
a processor; and
a memory device including instructions that are executable by the processor for causing the processor to:
receive, by a process engine distributed across a plurality of nodes of a distributed computing environment, a description of a process comprising a plurality of deployment units, the process associated with a graph representing a plurality of tasks to be performed to complete the process, the description defining relationships between the plurality of deployment units;
deploy, by the process engine, the plurality of deployment units in the distributed computing environment; and
cause, by the process engine, an action associated with an execution of one or more deployment units of the plurality of deployment units.

2. The system of claim 1, wherein the memory device further includes instructions that are executable by the processor for causing the processor to:
receive, subsequent to deploying the plurality of deployment units, a command to execute the process;
determine a first deployment unit of the plurality of deployment units that is to be executed subsequent to a second deployment unit of the plurality of deployment units and prior to a third deployment unit of the plurality of deployment units based on the description;
receive, from the second deployment unit subsequent to executing the second deployment unit, an indication of an end of an execution phase of the second deployment unit; and
cause, in response to receiving the indication, the action by triggering the execution of the first deployment unit.

3. The system of claim 1, wherein the memory device further includes instructions that are executable by the processor for causing the processor to:
receive, subsequent to deploying the plurality of deployment units, a command to execute the process;
determine that the process is incomplete; and
cause the action by outputting a report indicating that the process is incomplete.

4. The system of claim 1, wherein the memory device further includes instructions that are executable by the processor for causing the processor to:
receive a plurality of manifests describing the plurality of deployment units, wherein each manifest of the plurality of manifests corresponds to a deployment unit of the plurality of deployment units, wherein each manifest comprises an identifier of a communication channel associated with the deployment unit; and
provide, by the process engine, the communication channel between each deployment unit of the plurality of deployment units.

5. The system of claim 4, wherein the memory device further includes instructions that are executable by the processor for causing the processor to:
receive, by the process engine, a message associated with a first deployment unit of the plurality of deployment units; and
send the message to a second deployment unit of the plurality of deployment units, the second deployment unit configured to propagate the message to the first deployment unit via the communication channel.

6. The system of claim 1, wherein the memory device further includes instructions that are executable by the processor for causing the processor to:
determine that a deployment unit of the plurality of deployment units receives a number of requests above a threshold; and
cause a node of the distributed computing environment executing the deployment unit to be scaled up based on the number of requests being above the threshold.

7. The system of claim 1, wherein the action comprises creating a process instance of the process by performing the execution of the plurality of deployment units, manipulating a lifecycle of the process instance by starting, stopping, resuming, or restarting the process instance, manipulating a property associated with the process instance by adjusting a runtime state of the process during the execution of the plurality of deployment units, or tracing the execution of the plurality of deployment units through execution metrics associated with the process.

8. The system of claim 1, wherein the description comprises a business process model and notation file defining the graph associated with the process, and wherein each deployment unit of the plurality of deployment units comprises a containerized service including one or more tasks of the plurality of tasks of the process.

9. A method comprising:
receiving, by a process engine distributed across a plurality of nodes of a distributed computing environment, a description of a process comprising a plurality of deployment units, the process associated with a graph representing a plurality of tasks to be performed to complete the process, the description defining relationships between the plurality of deployment units;
deploying, by the process engine, the plurality of deployment units in the distributed computing environment; and
causing, by the process engine, an action associated with an execution of one or more deployment units of the plurality of deployment units.

10. The method of claim 9, further comprising:
receiving, subsequent to deploying the plurality of deployment units, a command to execute the process;
determining a first deployment unit of the plurality of deployment units that is to be executed subsequent to a second deployment unit of the plurality of deployment units and prior to a third deployment unit of the plurality of deployment units based on the description;
receiving, from the second deployment unit subsequent to executing the second deployment unit, an indication of an end of an execution phase of the second deployment unit; and
causing, in response to receiving the indication, the action by triggering the execution of the first deployment unit.

11. The method of claim 9, further comprising:
receiving, subsequent to deploying the plurality of deployment units, a command to execute the process;
determining that the process is incomplete; and
causing the action by outputting a report indicating that the process is incomplete.

12. The method of claim 9, further comprising:
receiving a plurality of manifests describing the plurality of deployment units, wherein each manifest of the plurality of manifests corresponds to a deployment unit of the plurality of deployment units, wherein each manifest comprises an identifier of a communication channel associated with the deployment unit; and
providing, by the process engine, the communication channel between each deployment unit of the plurality of deployment units.

13. The method of claim 12, further comprising:
receiving, by the process engine, a message associated with a first deployment unit of the plurality of deployment units; and
sending the message to a second deployment unit of the plurality of deployment units, the second deployment unit configured to propagate the message to the first deployment unit via the communication channel.

14. The method of claim 9, further comprising:
determining that a deployment unit of the plurality of deployment units receives a number of requests above a threshold; and
causing a node of the distributed computing environment executing the deployment unit to be scaled up based on the number of requests being above the threshold.

15. The method of claim 9, wherein the action comprises creating a process instance of the process by performing the execution of the plurality of deployment units, manipulating a lifecycle of the process instance by starting, stopping, resuming, or restarting the process instance, manipulating a property associated with the process instance by adjusting a runtime state of the process during the execution of the plurality of deployment units, or tracing the execution of the plurality of deployment units through execution metrics associated with the process.

16. The method of claim 9, wherein the description comprises a business process model and notation file defining the graph associated with the process, and wherein each deployment unit of the plurality of deployment units comprises a containerized service including one or more tasks of the plurality of tasks of the process.

17. A non-transitory computer-readable medium comprising program code that is executable by a processor for causing the processor to:
receive, by a process engine distributed across a plurality of nodes of a distributed computing environment, a description of a process comprising a plurality of deployment units, the process associated with a graph representing a plurality of tasks to be performed to complete the process, the description defining relationships between the plurality of deployment units;
deploy, by the process engine, the plurality of deployment units in the distributed computing environment; and
cause, by the process engine, an action associated with an execution of one or more deployment units of the plurality of deployment units.

18. The non-transitory computer-readable medium of claim 17, further comprising program code that is executable by the processor for causing the processor to:
receive, subsequent to deploying the plurality of deployment units, a command to execute the process;
determine a first deployment unit of the plurality of deployment units that is to be executed subsequent to a second deployment unit of the plurality of deployment units and prior to a third deployment unit of the plurality of deployment units based on the description;
receive, from the second deployment unit subsequent to executing the second deployment unit, an indication of an end of an execution phase of the second deployment unit; and
cause, in response to receiving the indication, the action by triggering the execution of the first deployment unit.

19. The non-transitory computer-readable medium of claim 17, further comprising program code that is executable by the processor for causing the processor to:
receive a plurality of manifests describing the plurality of deployment units, wherein each manifest of the plurality of manifests corresponds to a deployment unit of the plurality of deployment units, wherein each manifest comprises an identifier of a communication channel associated with the deployment unit; and
provide, by the process engine, the communication channel between each deployment unit of the plurality of deployment units.

20. The non-transitory computer-readable medium of claim 19, further comprising program code that is executable by the processor for causing the processor to:
receive, by the process engine, a message associated with a first deployment unit of the plurality of deployment units; and
send the message to a second deployment unit of the plurality of deployment units, the second deployment unit configured to propagate the message to the first deployment unit via the communication channel.
